(19) United States
(12) Patent Application Publication
(10) Pub. No.: US 2026/0050675 A1
(43) Pub. Date: Feb. 19, 2026

(54) SYSTEM AND APPARATUS SUITABLE FOR FACILITATING TRUSTWORTHINESS ASSESSMENT, AND A PROCESSING METHOD IN ASSOCIATION THERETO

(71) Applicants: Continental Automotive Technologies GmbH, Hannover (DE); NANYANG TECHNOLOGICAL UNIVERSITY, Singapore (SG)

(72) Inventors: SHEIKH HABIB MAHBUB, Munchen (DE); JIANWEN SUN, Singapore (SG)

(21) Appl. No.: 19/101,099

(22) PCT Filed: Jul. 27, 2023
(86) PCT No.: PCT/EP2023/070863

§ 371 Date: Feb. 4, 2025

(30) Foreign Application Priority Data
Aug. 4, 2022 (GB) 2211354.2

(51) Int. Cl. G06F 21/57

(52) U.S. Cl. CPC G06F 21/577; G06F 2221/033

(57) ABSTRACT

There is provided an apparatus suitable for use for facilitating trustworthiness assessment. The apparatus can include a first module and a second module. The first module can be configured to receive at least one input signal which can be processed by the second module to generate one or more output signals. The input signal(s) can be associated with at least one user requirement and/or at least one security objective. The input signal(s) can be processed by manner of identifying at least one security metric associated with at least one security requirement. The security requirement(s) can be based on at least one user requirement and/or at least one security objective, determining a positive determination, a negative determination or an indeterminate determination concerning fulfillment of a security metric in respect of at least one security objective and/or at least one user requirement and deriving at least one trustworthiness score accordingly.

### FIELD OF INVENTION

The present disclosure generally relates to one or both of a system and an apparatus suitable for facilitating trustworthiness assessment. Specifically, the present disclosure can relate to a system and/or an apparatus suitable for facilitating trustworthiness assessment in association with, for example, software in relation to an automotive system (e.g., an automotive software system), in accordance with an embodiment of the disclosure. The present disclosure further relates a processing method which can be associated with the system and/or the apparatus.

### BACKGROUND

Generally, software-based (e.g., computer codes) control of vehicles can considered to be more prevalent. It is contemplated that software failure(s)/vulnerabilities can potentially affect functionality and safety of one or more critical vehicle systems which may lead to concerns regarding safety and/or reliability. Failure(s) and/or vulnerabilities can be generally caused by software bugs, which can cause a corresponding piece of software to behave in an unintended manner. Such an unintended manner can, in one example, be in a form of an additional functionality which was not considered by the developer. In another example, an unexpected system crash can occur while executing the software.

Currently, various techniques have been utilized to attempt to identify and/or analyze vulnerabilities to facilitate in minimizing potential failures. Such techniques can, for example, include formal verification, static/dynamic analysis of code and fuzzing.

The present disclosure contemplates that conventional techniques do not facilitate identification and/or analysis of vulnerabilities in an effective manner as software patches appear to be required more often than desired/necessary, and there is a need to address (or at least mitigate) such an /sue/ such issues.

### SUMMARY OF THE INVENTION

In accordance with an aspect of the disclosure, there is provided an apparatus suitable for use for facilitating trustworthiness assessment in association with, for example, a vehicle. The vehicle can, for example, be associated with a system infrastructure (e.g., a software-based infrastructure). For example, the system infrastructure associated with a vehicle can correspond to the earlier mentioned automotive-based software system, in accordance with an embodiment of the disclosure. Moreover, trustworthiness assessment can, for example, be based on one or both of at least one trustworthiness score and an overall score, in accordance with an embodiment of the disclosure. It is contemplated that the trustworthiness score(s) and/or the overall score can, for example, be an indicative assessment of trustworthiness in association with the system infrastructure, in accordance with an embodiment of the disclosure. In one embodiment, the apparatus can be suitable for use for facilitating trustworthiness assessment in association with an automotive software system.

In one embodiment, the apparatus can, for example include a first module and a second module. The first module can, for example, be coupled to the second module.

The first module can, for example, be configured to receive at least one input signal and the second module can, for example, be configured to process the input signal(s) in a manner so as so to generate one or more output signals.

The input signal(s) can, for example, be associated with one or both of at least one user requirement and at least one security objective (i.e., at least one user requirement and/or at least one security objective; at least one of at least one user requirement and at least one security objective), in accordance with an embodiment of the disclosure.

Moreover, in one embodiment, the input signal(s) can be processed by manner of:
identifying (e.g., by manner of feature selection-based processing) at least one security metric associated with at least one security requirement. The security requirement(s) can, for example, be based on at least one user requirement and/or at least one security objective, in accordance with an embodiment of the disclosure
determining (e.g., by manner of analysis-based processing) a positive determination, a negative determination or an indeterminate determination (i.e., one of a positive determination, a negative determination and an indeterminate determination) concerning fulfillment of a security metric in respect of at least one security objective and/or at least one user requirement
deriving (e.g., by manner of analysis-based processing) at least one trustworthiness score based on the positive determination, the negative determination or the indeterminate determination (i.e., one of the positive determination, the negative determination and the indeterminate determination)

In one embodiment, the output signal(s) can, for example, be based on the trustworthiness score(s). Moreover, the output signal(s) can be indicative of trustworthiness assessment, in accordance with an embodiment of the disclosure.

In one embodiment, the second module can, for example, be configured to process the input signal(s) by manner of identifying a plurality of security metrics. Each security metric (of the plurality of security metrics) can, for example, be associated with at least one security objective and/or at least one user requirement. A trustworthiness score can, for example, be derived in association with each security metric based on a positive determination, a negative determination or an indeterminate determination (i.e., one of a positive determination, a negative determination and an indeterminate determination) concerning fulfillment of a security metric in respect of a security objective and/or a user requirement, in accordance with an embodiment of the disclosure.

In one embodiment, the second module can, for example, be configured to derive a plurality of trustworthiness scores based on a plurality of security metrics.

In one embodiment, the second module can, for example, be configured to aggregate the plurality of trustworthiness scores to generate an overall score. Additionally, trustworthiness assessment can, for example, be based on the overall score, in accordance with an embodiment of the disclosure.

In one embodiment, the apparatus can, for example, further include a third module which can, for example, be configured to communicate the output signal(s) to facilitate one or both of visual perception and audible perception (i.e., visual perception and/or audible perception, at least one of visual perception and audible perception) of one or both of the trustworthiness score(s) and the overall score (i.e., the trustworthiness score(s) and/or the overall score; at least one of the trustworthiness score(s) and the overall score).

It is contemplated that in the above manner at least one measurable assessment result of trustworthiness (i.e., trustworthiness assessment) can be facilitated, in accordance with an embodiment of the disclosure. Specifically, it is appreciable that the aforementioned trustworthiness score(s) and/or the overall score can, for example, relate to/correspond to at least one measurable assessment result of trustworthiness, in accordance with an embodiment of the disclosure.

It is contemplated that facilitating measurable assessment result of trustworthiness can, for example, facilitate a quantifiable overview of an automotive-based software system during the lifecycle of, for example, a vehicle (e.g., a car), in accordance with an embodiment of the disclosure. Such a quantifiable overview can, for example, be useful for, for example, a party of interest (e.g., developer(s), software architect(s), system architect(s) and/or security & privacy manager(s)). For example, identifying security metrics associated with an automotive-based software system trustworthiness can possibly generate one or more quantified scores associated with one or more security risks during development and/or deployment phase, which provides a party of interest (e.g., developer(s) and/or other stakeholder(s)) a brief and/or intuitive security assessment. It is contemplated that, in accordance with an embodiment of the disclosure, trustworthiness assessment can, for example, be communicated via an interactive dashboard (e.g., an electronic dashboard module) which can, for example, facilitate traceability of security defects in software modules/platforms associated with an automotive-based software system.

Moreover, it is contemplated that by manner of facilitating measurable assessment result of trustworthiness (i.e., trustworthiness evaluation), cybersecurity health of an automotive-based software system can be assessed before a vehicle is on the road. By doing so, the number of product (e.g., a vehicle) recalls due to software defects can potentially be at least reduced. Additionally, software defects can possibly be addressed during development lifecycle phase. In this regard, it is appreciable that overall software product development can, for example, be made more efficient and/or maintenance costs can possibly be reduced, in accordance with an embodiment of the disclosure.

It is contemplated that facilitating measurable assessment result of trustworthiness (i.e., trustworthiness evaluation) can be useful for, for example, assessing the security risks and generating a trustworthiness report, which can build the software trustworthiness databases for risk assessment during development phase, in accordance with an embodiment of the disclosure. It is further contemplated that facilitating measurable assessment result of trustworthiness (i.e., trustworthiness evaluation) can be useful for, for example, assigning one or more trustworthiness scores for automotive software modules associated with an automotive-based software system for one or more relevant stakeholders (e.g., user(s) of vehicle(s) and/or software architect(s)) so as to, for example, improve security level, in accordance with an embodiment of the disclosure (e.g., in connection with the aftermarket phase).

The above-described advantageous aspect(s) of the apparatus of the present disclosure can also apply analogously (all) the aspect(s) of a below described processing method of the present disclosure. Likewise, all below described advantageous aspect(s) of the processing method of the disclosure can also apply analogously (all) the aspect(s) of above described apparatus of the disclosure.

In accordance with an aspect of the disclosure, there is provided a processing method which can, for example, be suitable for facilitation of trustworthiness assessment, in accordance with an embodiment of the disclosure. Trustworthiness assessment can be in association with, for example, a vehicle. The vehicle can, for example, be associated with a system infrastructure (e.g., a software-based infrastructure). For example, the system infrastructure associated with a vehicle can correspond to the earlier mentioned automotive-based software system, in accordance with an embodiment of the disclosure. Moreover, trustworthiness assessment can, for example, be based on one or both of at least one trustworthiness score and an overall score, in accordance with an embodiment of the disclosure. It is contemplated that the trustworthiness score(s) and/or the overall score can, for example, be an indicative assessment of trustworthiness in association with the system infrastructure, in accordance with an embodiment of the disclosure. In one embodiment, the processing method can, for example, be suitable for facilitating trustworthiness assessment in association with an automotive software system.

The processing method can, for example, include an analysis step, in accordance with an embodiment of the disclosure.

In one embodiment, the analysis step can, for example, include processing (e.g., by the apparatus as mentioned earlier, in accordance with an aspect of the disclosure) at least one input signal to generate at least one output signal.

The input signal(s) can, for example, be associated with/include/be indicative of one or both of at least one user requirement and at least one security objective (i.e., at least one user requirement and/or at least one security objective; at least one of at least one user requirement and at least one security objective).

In one embodiment, the input signal(s) can, for example, be processed by manner of:
identifying (e.g., by manner of feature selection-based processing) at least one security metric associated with at least one security requirement. The security requirement(s) can, for example, be based on the security objective(s) and/or the user requirement(s), in accordance with an embodiment of the disclosure.
determining (e.g., by manner of analysis-based processing) a positive determination, a negative determination or an indeterminate determination (i.e., one of a positive determination, a negative determination and an indeterminate determination) concerning fulfillment of a security metric in respect of at least one security objective and/or at least one user requirement
deriving (e.g., by manner of analysis-based processing) at least one trustworthiness score based on the positive determination, the negative determination or the indeterminate determination (i.e., one of the positive determination, the negative determination and the indeterminate determination)

In one embodiment, the output signal(s) can, for example, be based on the trustworthiness score(s).

In one embodiment, the output signal(s) can, for example, be indicative of trustworthiness assessment.

In one embodiment, the input signal(s) can, for example, be processed by manner of identifying a plurality of security metrics. Each security metric of the plurality of security metrics can, for example, be associated with at least one security objective and/or at least one user requirement.

In one embodiment, a trustworthiness score can, for example, be derived in association with each security metric based on a positive determination, a negative determination or an indeterminate determination (i.e., one of a positive determination, a negative determination and an indeterminate determination) concerning fulfillment of a security metric in respect of a security objective and/or a user requirement.

In one embodiment, a plurality of trustworthiness scores can, for example, be derived based on a plurality of security metrics.

In one embodiment, the processing method can, for example, further include aggregating the plurality of trustworthiness scores to generate an overall score.

In one embodiment, trustworthiness assessment can, for example, be based on the overall score.

It is contemplated that in the above manner at least one measurable assessment result of trustworthiness (i.e., trustworthiness assessment) can be facilitated, in accordance with an embodiment of the disclosure. Specifically, it is appreciable that the aforementioned trustworthiness score(s) and/or the overall score can, for example, relate to/correspond to at least one measurable assessment result of trustworthiness, in accordance with an embodiment of the disclosure.

It is contemplated that facilitating measurable assessment result of trustworthiness can, for example, facilitate a quantifiable overview of an automotive-based software system during the lifecycle of, for example, a vehicle (e.g., a car), in accordance with an embodiment of the disclosure. Such a quantifiable overview can, for example, be useful for, for example, a party of interest (e.g., developer(s), software architect(s), system architect(s) and/or security & privacy manager(s)). For example, identifying security metrics associated with an automotive-based software system trustworthiness can possibly generate one or more quantified scores associated with one or more security risks during development and/or deployment phase, which provides a party of interest (e.g., developer(s) and/or other stakeholder(s)) a brief and/or intuitive security assessment. It is contemplated that, in accordance with an embodiment of the disclosure, trustworthiness assessment can, for example, be communicated via an interactive dashboard (e.g., an electronic dashboard module) which can, for example, facilitate traceability of security defects in software modules/platforms associated with an automotive-based software system.

Moreover, it is contemplated that by manner of facilitating measurable assessment result of trustworthiness (i.e., trustworthiness evaluation), cybersecurity health of an automotive-based software system can be assessed before a vehicle is on the road. By doing so, the number of product (e.g., a vehicle) recalls due to software defects can potentially be at least reduced. Additionally, software defects can possibly be addressed during development lifecycle phase. In this regard, it is appreciable that overall software product development can, for example, be made more efficient and/or maintenance costs can possibly be reduced, in accordance with an embodiment of the disclosure.

It is contemplated that facilitating measurable assessment result of trustworthiness (i.e., trustworthiness evaluation) can be useful for, for example, assessing the security risks and generating a trustworthiness report, which can build the software trustworthiness databases for risk assessment during development phase, in accordance with an embodiment of the disclosure. It is further contemplated that facilitating measurable assessment result of trustworthiness (i.e., trustworthiness evaluation) can be useful for, for example, assigning one or more trustworthiness scores for automotive software modules associated with an automotive-based software system for one or more relevant stakeholders (e.g., user(s) of vehicle(s) and/or software architect(s)) so as to, for example, improve security level, in accordance with an embodiment of the disclosure (e.g., in connection with the aftermarket phase).

The present disclosure further contemplates a computer program which can include instructions which, when the program is executed by a computer, cause the computer to carry out the analysis step as discussed with reference to the processing method.

The present disclosure yet further contemplates a computer readable storage medium (not shown) having data stored therein representing software executable by a computer, the software including instructions, when executed by the computer, to carry out the analysis step as discussed with reference to the processing method.

### BRIEF DESCRIPTION OF THE DRAWINGS

Embodiments of the disclosure are described hereinafter with reference to the following drawings, in which:

FIG. 1 shows a system which can include at least one apparatus, according to an embodiment of the disclosure;

FIG. 2 shows the apparatus of FIG. 1 in further detail, according to an embodiment of the disclosure; and

FIG. 3 shows a processing method in association with the system of FIG. 1, according to an embodiment of the disclosure.

### DETAILED DESCRIPTION

The present disclosure contemplates that software patching could have an undesirable economic impact (e.g., increased costs) in association with, for example, the automotive domain, in accordance with an embodiment of the disclosure. For example, software patching could potentially be expensive once a vehicle is in production phase or already on the road.

It is contemplated that providing, for example, a framework for evaluating trustworthiness in connection with an automotive system can be helpful, in accordance with an embodiment of the disclosure. For example, the present disclosure contemplates that a framework for evaluating software trustworthiness in connection with an automotive-based software system (e.g., a software system in association with a vehicle such as an automobile) can be helpful in at least reducing the frequency of (or, preferably, eliminating the need for) software patching occurrences.

The present disclosure contemplates that software trustworthiness can, for example, be considered as a degree of confidence that exists that a set of requirements has been met. It is further contemplated that trustworthiness associated with software can be used to assess one or more automotive software modules associated with an automotive-based software system by manner of, for example, providing/deriving one or more trustworthiness scores, in accordance with an embodiment of the disclosure. The trustworthiness score(s) can, for example, be provided/derived based one or more perspectives (e.g., multi-dimensional), in accordance with an embodiment of the disclosure.

It is contemplated that facilitating measurable assessment result of trustworthiness can, for example, facilitate a quantifiable overview of an automotive-based software system during the lifecycle of, for example, a vehicle (e.g., a car), in accordance with an embodiment of the disclosure. Such a quantifiable overview can, for example, be useful for, for example, a party of interest (e.g., developer(s), software architect(s), system architect(s) and/or security & privacy manager(s)). For example, identifying security metrics associated with an automotive-based software system trustworthiness can possibly generate one or more quantified scores associated with one or more security risks during development and/or deployment phase, which provides a party of interest (e.g., developer(s) and/or other stakeholder(s)) a brief and/or intuitive security assessment. It is contemplated that, in accordance with an embodiment of the disclosure, trustworthiness assessment can, for example, be communicated via an interactive dashboard (e.g., an electronic dashboard module) which can, for example, facilitate traceability of security defects in software modules/platforms associated with an automotive-based software system.

Moreover, it is contemplated that by manner of facilitating measurable assessment result of trustworthiness (i.e., trustworthiness evaluation), cybersecurity health of an automotive-based software system can be assessed before a vehicle is on the road. By doing so, the number of product (e.g., a vehicle) recalls due to software defects can potentially be at least reduced. Additionally, software defects can possibly be addressed during development lifecycle phase. In this regard, it is appreciable that overall software product development can, for example, be made more efficient and/or maintenance costs can possibly be reduced, in accordance with an embodiment of the disclosure.

It is contemplated that facilitating measurable assessment result of trustworthiness (i.e., trustworthiness evaluation) can be useful for, for example, assessing the security risks and generating a trustworthiness report, which can build the software trustworthiness databases for risk assessment during development phase, in accordance with an embodiment of the disclosure. It is further contemplated that facilitating measurable assessment result of trustworthiness (i.e., trustworthiness evaluation) can be useful for, for example, assigning one or more trustworthiness scores for automotive software modules associated with an automotive-based software system for one or more relevant stakeholders (e.g., user(s) of vehicle(s) and/or software architect(s)) so as to, for example, improve security level, in accordance with an embodiment of the disclosure (e.g., in connection with the aftermarket phase).

The foregoing will be discussed in further detail with reference to FIG. 1 to FIG. 3 hereinafter.

Referring to FIG. 1, a system 100 is shown, according to an embodiment of the disclosure. As shown, the system 100 can include one or more apparatuses 102, at least one device 104 and, optionally, a communication network 106, in accordance with an embodiment of the disclosure.

The apparatus(es) 102 can be coupled to the device(s) 104. Specifically, the apparatus(es) 102 can, for example, be coupled to the device(s) 104 via the communication network 106.

In one embodiment, the apparatus(es) 102 can be coupled to the communication network 106 and the device(s) 104 can be coupled to the communication network 106. Coupling can be by manner of one or both of wired coupling and wireless coupling. The apparatus(es) 102 can, in general, be configured to communicate with the device(s) 104 via the communication network 106, according to an embodiment of the disclosure.

Generally, in accordance with an embodiment of the disclosure, the apparatus(es) 102 can be configured to receive one or more input signals and process the input signal(s) to generate/derive one or more output signals. Moreover, in accordance with an embodiment of the disclosure, the device(s) 104 can, for example, be configured to one or both of generate the input signal(s) and communicate the input signal(s) to the apparatus(es) 102.

The system 100 can, for example, be suitable for facilitating trustworthiness evaluation, in accordance with an embodiment of the disclosure. Facilitation of trustworthiness evaluation can, for example, relate to facilitation of measurable assessment result of trustworthiness, in accordance with an embodiment of the disclosure.

It is generally contemplated that the system 100 can, for example, relate to/correspond to/include a framework in association with software trustworthiness evaluation which can, for example, be focused on defining measurable security metrics from one or more perspectives that can be used to assess (e.g., automatically assess) one or more trustworthiness scores for one or more software modules which can be included in a software system, in accordance with an embodiment of the disclosure. The software system can, for example, correspond to/be associated with an automotive-based software system, in accordance with an embodiment of the disclosure.

In one embodiment, the framework can, for example, include/be associated with:
deriving/defining one or more security metrics, and
assessing/evaluating the security metric(s),
   as will be discussed in turn hereinafter in accordance with an embodiment of the disclosure.

It is contemplated that to derive/define one or more appropriate/useful security metrics (e.g., correct metrics), one or more parameters should be established, in accordance with an embodiment of the disclosure. The parameter(s) can, for example, include/be based on/be associated with any one of:
at least one security environment,
at least one security objective and
at least one security requirement,
   or any combination thereof, in accordance with an embodiment of the disclosure.

In one embodiment, the parameter(s) can, for example, be based on security environment, security objective(s) and security requirement(s).

The security environment can, for example, be associated with at least one threat model and at least one attack surface analysis, which can be useful for analyzing one or more adversaries' malicious intention(s).

The security objective(s) can, for example, be associated with identification of one or more goals and/or constraints that affect the system 100, which can be useful for directing one or more subsequent security activities.

The security requirement(s) can, for example, be based on one or both of the security objective(s) and user requirement(s). Generally, the security requirement(s) can, for example, be based on security assurance and/or security functionality. The security requirements can, for example, be used to define corresponding one or more security metrics which can be used for assessing trustworthiness (i.e., trustworthiness evaluation).

The present disclosure contemplates that by doing so, it is appreciable that one or more security risks associated with one or more software modules/components of a software system can possibly be quantifiable, in accordance with an embodiment of the disclosure.

It is contemplated that the derived/defined security metric(s) can be assessed (e.g., automatically assessed) based on, for example, evidence extracted from one or more different testing tools and industry-related standards & regulations, in accordance with an embodiment of the disclosure. Based on the assessment in association with a security metric, a trustworthiness metric can possibly be used to generate a trustworthiness score, in accordance with an embodiment of the disclosure. For example, evidence regarding different security metrics can be further aggregated using at least one trustworthiness metric to generate one or more trustworthiness scores. As an option, the trustworthiness scores can, for example, be aggregated into an overall score for a software component/module, in accordance with an embodiment of the disclosure.

The system 100 will now be discussed based on an example context of an automotive-based software system in association with a vehicle (e.g., an automobile), in accordance with an embodiment of the disclosure, hereinafter.

In this regard, in the example context, the earlier mentioned security objective(s) can be established based on standard(s) and regulation(s) in relation to the automotive field/domain. Moreover, the security objective(s) can identify goal(s) and constraint(s) that affect automotive-based system(s). Additionally, the derived/defined security metric(s), as discussed earlier, can be assessed (e.g., automatically assessed) based on, for example, evidence extracted from one or more different testing tools and automotive cybersecurity standards & regulations. Furthermore, the earlier mentioned security requirement(s) can be based on the guidance of security objectives and automotive related OEM (Original Equipment Manufacturer) requirement(s).

As mentioned earlier, the system 100 can include one or more apparatuses 102, at least one device 104 and, optionally, a communication network 106, in accordance with an embodiment of the disclosure.

The apparatus(es) 102 can, for example, correspond to one or more computers (e.g., an electronic device/module having computing capabilities such as an electronic mobile device which can be carried into a vehicle or an electronic module such as an electronic dashboard module which can be installed in a vehicle, by manner of, for example, “plug and play” or existing electronic control unit or ECU having high performance computing capabilities and connected to the existing vehicle network to receive all types of vehicle data, sensor data and user data), in accordance with an embodiment of the disclosure. The apparatus(es) 102 can, in one embodiment, include one or more processors (not shown) which can be configured to perform one or more processing tasks.

Generally, as mentioned earlier, the apparatus(es) 102 can be configured to receive the input signal(s) and to process the input signal(s) in a manner so as to generate/derive one or more output signal(s), in accordance with an embodiment of the disclosure. The input signal(s) can, for example, correspond to/include/be indicative of one or both of the security objective(s) (e.g., security objective(s) established based on standard(s) and regulation(s) in relation to the automotive field) and the user requirement(s) (e.g., OEM requirements), in accordance with an embodiment of the disclosure.

The apparatus(es) 102 can, for example, be configured to process the input signal(s) by manner of any one of feature selection-based processing, analysis-based processing and aggregation-based processing, or any combination thereof (i.e., feature selection-based processing, analysis-based processing and/or aggregation-based processing) to generate/derive the output signal(s), in accordance with an embodiment of the disclosure.

In regard to feature selection-based processing, the apparatus(es) 102 can, for example, be configured to identify/extract/define one or more parameters in connection with the security requirement(s) which can be based on the security objective(s) and/or the user requirement(s). The identified/extracted/defined parameter(s) can, for example, correspond to/include/be associated with one or more security metrics which can be associated with the security requirement(s).

In regard to analysis-based processing, the apparatus(es) 102 can, for example, be configured to generate/derive one or more trustworthiness scores associated with the security metrics. For example, one trustworthiness score can be derived in association with one security metric. In one embodiment, the trustworthiness score(s) can be generated/derived based on one or more analysis techniques can be include any one of penetration testing, fuzzing, vulnerability assessment and model-based assessment, or any combination thereof.

In regard to aggregation-based processing, the apparatus(es) 102 can, for example, be configured to aggregate the trustworthiness score(s) so as to generate an overall score (e.g., an overall trustworthiness score).

The output signal(s) can, for example, correspond to/include/be indicative of one or both of the trustworthiness score(s) and the overall score (i.e., trustworthiness score(s) and/or overall score), in accordance with an embodiment of the disclosure. In one example, an output signal can correspond to a trustworthiness score and another output signal can correspond to another trustworthiness score. In another example, an output signal can correspond to a trustworthiness score, another output signal can correspond to another trustworthiness score and yet another output signal can correspond to the overall score. In yet another example, the output signal(s) can correspond to the worthiness score(s). In yet a further example, the output signal(s) can correspond to the overall score.

The device(s) 104 can, for example, be configured to generate the input signal(s) and/or communicate the input signal(s), in accordance with an embodiment of the disclosure. For example, the input signal(s) can be communicated from the device(s) 104 to the apparatus(es) 102. In one example, the device(s) 104 can be associated with/correspond to/include one or more databases (e.g., publicly available online database(s) and/or private database(s)) which can be associated with known/established industry standards and regulations (e.g., standards and regulations relevant to the automotive field) and one or more input signals associable with/corresponding to/including such known/established industry standards and regulations can be communicated from the device(s) 104. In another example, the device(s) 104 can be usable by one or more users (e.g., one or more users associated with an OEM) to generate one or more input signals which can include/be associated with/correspond to the user requirement(s) (e.g., OEM requirement(s)) and the generated input signal(s) can be communicated from the device(s) 104. In yet another example, the device(s) 104 can be configured to communicate one or more input signals associable with/corresponding to/including known/established industry standards and regulations, and generate one or more input signals which can include/be associated with/correspond to the user requirement(s). In yet a further example one or more devices 104 can be configured to communicate one or more input signals associable with/corresponding to/including known/established industry standards and regulations, and another one or more devices 104 can be configured to generate one or more input signals which can include/be associated with/correspond to the user requirement(s).

The communication network 106 can, for example, correspond to an Internet communication network, a wired-based communication network, a wireless-based communication network, or any combination thereof. Communication (i.e., between the apparatus(es) 102 and the device(s) 104) via the communication network 106 can be by manner of one or both of wired communication and wireless communication.

The above example context will now be discussed in further detail based on a first example scenario and a second example scenario, in accordance with an embodiment of the disclosure hereinafter.

The first example scenario can, for example, be in relation to an infotainment system associated with a vehicle, in accordance with an embodiment of the disclosure. It is contemplated that an infotainment system can relate to/be associated with the control area network (CAN) component of a vehicle. Moreover, an infotainment system can be capable of providing wireless connection to an Internet/Cloud service which can be a potential huge attack surface exposure for malicious adversaries. It is contemplated that the security objective(s) and/or user requirement(s) in association with an infotainment system can be based on/correspond to a number of categories. In one specific example, the security objective(s) and/or user requirement(s) in association with an infotainment system can be based on/correspond to five categories, namely “containers,” “encryption,” “separation,” “application source” and “remote connected applications” (e.g., five categories of security objective(s)/user requirement(s)). It is contemplated that for each category (e.g., for each category of security objective(s)/user requirement), one or more security metrics can possibly be defined/identified/extracted (e.g., by manner of feature selection-based processing as discussed earlier) based on the security requirement(s) (e.g., user requirement(s) from one or more users such as developers, customers and/or OEMs relevant parties).

For example, in connection with a category such as “separation”, a requirement associated with security development is that an infotainment system would require adequate (e.g., strong) separation to support different application domains. Accordingly, a plurality of security metrics can possibly be defined/extracted/identified based on such a requirement. In one specific example, any one of a first security metric, a second security metric and a third security metric, or any combination thereof, can be defined/extracted/identified. In a more specific example, the first security metric can relate to privilege separation which can be associated with a determination of whether protection on the unprivileged application that cannot obtain access to privileged system resources (e.g., CAN bus) has been/can be provided, the second security metric can relate to security domains which can be associated with a determination of whether a specific domain has been/can be defined and assigned to a different application and the third security metric can relate to container isolation which can be associated with a determination as to whether critical applications have been/can be isolated into containers. The security metric(s) can, for example, be subject to the earlier discussed analysis-based processing (which can, for example be akin to an evaluation process, in accordance with an embodiment of the disclosure). It is contemplated that a positive determination (e.g., “yes”), a negative determination (e.g., “no”) or an indeterminate determination (e.g., “unknown”/“not applicable”) in connection with the security metric(s) can be basis/bases for a multi-dimensional (e.g., multiple perspectives) trustworthiness score which can include/be associate with “trust” rating complemented with a “confidence” rating as well as “initial expectation” rating.

In a first general example, in regard to the first security metric, if it is positively determined (e.g., by the apparatus(es) 102 by manner of analysis-based processing) that protection on the unprivileged application that cannot obtain access to privileged system resources has been/can be provided, trustworthiness score can be higher as compared with a negative determination and/or an indeterminate determination. Conversely, if it is negatively determined (e.g., by the apparatus(es) 102 by manner of analysis-based processing) that protection on the unprivileged application that cannot obtain access to privileged system resources has been/can be provided, trustworthiness score can be lower as compared with a positive determination and/or an indeterminate determination. If there is indeterminate determination (e.g., by the apparatus(es) 102 by manner of analysis-based processing) concerning whether protection on the unprivileged application that cannot obtain access to privileged system resources has been/can be provided, trustworthiness score can be higher as compared with a negative determination but lower as compared with a positive determination. In this manner a first trustworthiness score can, for example, be determined (e.g., by the apparatus(es) 102 by manner of analysis-based processing) in association with the first security metric, in accordance with an embodiment of the disclosure.

In a second general example, in regard to the second security metric, if it is positively determined (e.g., by the apparatus(es) 102 by manner of analysis-based processing) that a specific domain has been/can be defined and assigned to a different application, trustworthiness score can be higher as compared with a negative determination and/or an indeterminate determination. Conversely, if it is negatively determined (e.g., by the apparatus(es) 102 by manner of analysis-based processing) that a specific domain has been/can be defined and assigned to a different application, trustworthiness score can be lower as compared with a positive determination and/or an indeterminate determination. If there is indeterminate determination (e.g., by the apparatus(es) 102 by manner of analysis-based processing) concerning whether a specific domain has been/can be defined and assigned to a different application, trustworthiness score can be higher as compared with a negative determination but lower as compared with a positive determination. In this manner a second trustworthiness score can, for example, be determined (e.g., by the apparatus(es) 102 by manner of analysis-based processing) in association with the second security metric, in accordance with an embodiment of the disclosure.

In a third general example, in regard to the third security metric, if it is positively determined (e.g., by the apparatus(es) 102 by manner of analysis-based processing) that critical applications have been/can be isolated into containers, trustworthiness score can be higher as compared with a negative determination and/or an indeterminate determination. Conversely, if it is negatively determined (e.g., by the apparatus(es) 102 by manner of analysis-based processing) that critical applications have been/can be isolated into containers, trustworthiness score can be lower as compared with a positive determination and/or an indeterminate determination. If there is indeterminate determination (e.g., by the apparatus(es) 102 by manner of analysis-based processing) concerning whether critical applications have been/can be isolated into containers, trustworthiness score can be higher as compared with a negative determination but lower as compared with a positive determination. In this manner a third trustworthiness score can, for example, be determined (e.g., by the apparatus(es) 102 by manner of analysis-based processing) in association with the third security metric, in accordance with an embodiment of the disclosure.

In the context of the above first, second and third general examples, a positive determination can, for example, be associated with a trustworthiness score of 90 out of a maximum score of 100 (e.g., a score of 90%), an indeterminate determination can, for example, be associated with a trustworthiness score of 50 out of a maximum score of 100 (e.g., a score of 50%) and a negative determination can, for example, be associated with a worthiness score of 10 out of a maximum score of 100 (e.g., a score of 10%), in accordance with an embodiment of the disclosure. For example, in the context of the first general example, when the apparatus(es) 102 can positively determine (i.e., a positive determination) that protection on the unprivileged application that cannot obtain access to privileged system resources has been/can be provided, the apparatus(es) 102 can be configured to generate a first trustworthiness score of 90%. Additionally, in the context of the second general example, when the apparatus(es) 102 can positively determine (i.e., a positive determination) that a specific domain has been/can be defined and assigned to a different application, the apparatus(es) 102 can be configured to generate a second trustworthiness score of 90%. Moreover, in the context of the third general example, when the apparatus(es) 102 negatively determine(s) (i.e., a negative determination) that critical applications have been/can be isolated into containers, the apparatus(es) 102 can be configured to generate a third trustworthiness score of 10%.

In this regard, in connection with the first example scenario, the multi-dimensional trustworthiness score can, for example, be based on any combination of the first trustworthiness score, the second trustworthiness score and the third trustworthiness score, in accordance with an embodiment of the disclosure. In one embodiment, the multi-dimensional trustworthiness score can, for example, be based on the first trustworthiness score, the second trustworthiness score and the third trustworthiness score. For example, the apparatus(es) 102 can, for example, be configured (e.g., by manner of performing at least one processing task in association with aggregation-based processing) to derive/generate the multi-dimensional trustiness score based on an aggregate (e.g., a computed average of 90%, 90% and 10% to derive an aggregated score of 63.33%) of the first trustworthiness score (e.g., 90%), the second trustworthiness score (e.g., 90%) and the third trustworthiness score (e.g., 10%), in accordance with an embodiment of the disclosure. It is appreciable that the earlier mentioned overall score can, for example, be associated with/correspond to/include the multi-dimensional trustworthiness score, in accordance with an embodiment of the disclosure. In one embodiment, the overall score can, for example, correspond to the multi-dimensional trustworthiness score.

The second example scenario can, for example, be in relation to an Over-the-Air (OTA) module associated with a vehicle, in accordance with an embodiment of the disclosure.

It is contemplated that software update(s) in connection with the software system of a vehicle by manner of OTA can be possible. However, there could potentially be concerns in regard to security vulnerabilities in connection with OTA based software update(s) as connecting an Electronic Control Unit (ECU) to, for example, the Internet may possibly cause the ECU to be potentially vulnerable to a wide range of attacks (e.g., cyberattacks). Moreover, a vulnerable update can potentially impact a vehicle's performance not only in terms of recalls or lost sales but also potentially in loss of life. The present disclosure contemplates that one or more security objectives can be defined in association with an OTA module for the purpose of avoiding/mitigating one or more attack types which can, for example, include endless data attack(s), mixed-bundle(s) attack(s), partial bundle installation attack(s) and freeze attack(s), in accordance with an embodiment of the disclosure. One or more security requirements can be defined for each attack type.

For example, in the context of an attack type such as the mixed-bundle(s) attack(s), the security requirement(s) can be defined as the need for meta-data to be broadcasted between primary (e.g., a primary device such as an OTA module) and one or more secondaries (e.g., one or more secondary devices such as one or more servers/databases from which software updates(s) can be carried). To meet this defined security requirement, one or more security metrics can be defined/extracted/identified. The security metric(s) can, for example, include any one of a first security metric, a second security metric and a third security metric, or any combination thereof, in accordance with an embodiment of the disclosure.

In the second example scenario, the first security metric can, for example, relate to bundle information synchronization where the apparatus(es) 102 can be configured to determine (e.g., by manner of analysis-based processing) whether the primary can have the capability to broadcast the metadata of the bundle information to all the secondaries. The second security metric can, for example, relate to trusted communication(s) between primary and one or more secondaries where the apparatus(es) 102 can be configured to determine (e.g., by manner of analysis-based processing) whether the ECU(s) authenticate(s) communication(s) (e.g., between the primary and one or more secondaries). The third security metric can, for example, relate to network reliability where the apparatus(es) 102 can be configured to determine (e.g., by manner of analysis-based processing) whether the network used to broadcast bundle information can be considered to be reliable.

Analogous to the first example scenario, in the second example scenario, the security metric(s) can, for example, be subject to the earlier discussed analysis-based processing (which can, for example be akin to an evaluation process, in accordance with an embodiment of the disclosure). It is contemplated that a positive determination (e.g., “yes”), a negative determination (e.g., “no”) or an indeterminate determination (e.g., “unknown”/“not applicable”) in connection with the security metric(s) can be basis/bases for a multi-dimensional trustworthiness score which can include/be associate with “trust” rating complemented with a “confidence” rating as well as “initial expectation” rating. In this regard, relevant portion(s) of the earlier discussion concerning the first example scenario can analogously apply to the second example scenario, as appropriate.

Specifically, the earlier discussion, in the context of the first example scenario, concerning the first, second and third general examples can analogously apply in the context of the second example scenario. In one example, in the second example scenario, a first trustworthiness score can, for example, be determined (e.g., by the apparatus(es) 102 by manner of analysis-based processing) in association with the first security metric based on a positive determination, a negative determination or an indeterminate determination concerning bundle information synchronization. In another example, in the second example scenario, a second trustworthiness score can, for example, be determined (e.g., by the apparatus(es) 102 by manner of analysis-based processing) in association with the second security metric based on a positive determination, a negative determination or an indeterminate determination concerning trusted communication(s) between primary and one or more secondaries. In yet another example, in the second example scenario, a third trustworthiness score can, for example, be determined (e.g., by the apparatus(es) 102 by manner of analysis-based processing) in association with the third security metric based on a positive determination, a negative determination or an indeterminate determination concerning network reliability.

In analogous manner as discussed with reference to the first example scenario, in the second example scenario, a multi-dimensional trustworthiness score (e.g., which can be associated with/correspond to/include the earlier mentioned overall score) can, for example, be based on any combination of the first trustworthiness score, the second trustworthiness score and the third trustworthiness score, in accordance with an embodiment of the disclosure.

It is contemplated that in the above manner at least one measurable assessment result of trustworthiness (i.e., trustworthiness assessment) can be facilitated, in accordance with an embodiment of the disclosure. Specifically, it is appreciable that the aforementioned trustworthiness score(s) and/or the overall score can, for example, relate to/correspond to at least one measurable assessment result of trustworthiness, in accordance with an embodiment of the disclosure.

It is contemplated that facilitating measurable assessment result of trustworthiness can, for example, facilitate a quantifiable overview of an automotive-based software system during the lifecycle of, for example, a vehicle (e.g., a car), in accordance with an embodiment of the disclosure. Such a quantifiable overview can, for example, be useful for, for example, a party of interest (e.g., developer(s), software architect(s), system architect(s) and/or security & privacy manager(s)). For example, identifying security metrics associated with an automotive-based software system trustworthiness can possibly generate one or more quantified scores associated with one or more security risks during development and/or deployment phase, which provides a party of interest (e.g., developer(s) and/or other stakeholder(s)) a brief and/or intuitive security assessment. It is contemplated that, in accordance with an embodiment of the disclosure, trustworthiness assessment can, for example, be communicated via an interactive dashboard (e.g., an electronic dashboard module) which can, for example, facilitate traceability of security defects in software modules/platforms associated with an automotive-based software system.

Moreover, it is contemplated that by manner of facilitating measurable assessment result of trustworthiness (i.e., trustworthiness evaluation), cybersecurity health of an automotive-based software system can be assessed before a vehicle is on the road.

By doing so, the number of product (e.g., a vehicle) recalls due to software defects can potentially be at least reduced. Additionally, software defects can possibly be addressed during development lifecycle phase. In this regard, it is appreciable that overall software product development can, for example, be made more efficient and/or maintenance costs can possibly be reduced, in accordance with an embodiment of the disclosure.

It is contemplated that facilitating measurable assessment result of trustworthiness (i.e., trustworthiness evaluation) can be useful for, for example, assessing the security risks and generating a trustworthiness report, which can build the software trustworthiness databases for risk assessment during development phase, in accordance with an embodiment of the disclosure. It is further contemplated that facilitating measurable assessment result of trustworthiness (i.e., trustworthiness evaluation) can be useful for, for example, assigning one or more trustworthiness scores for automotive software modules associated with an automotive-based software system for one or more relevant stakeholders (e.g., user(s) of vehicle(s) and/or software architect(s)) so as to, for example, improve security level, in accordance with an embodiment of the disclosure (e.g., in connection with the aftermarket phase).

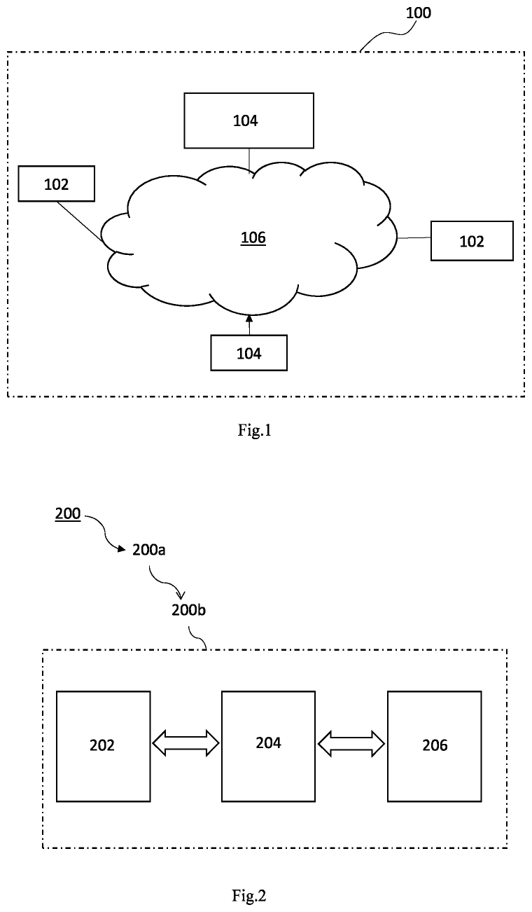

The aforementioned apparatus(es) 102 will be discussed in further detail with reference to FIG. 2 hereinafter.

Referring to FIG. 2, an apparatus 102 is shown in further detail in the context of an example implementation 200, according to an embodiment of the disclosure.

In the example implementation 200, the apparatus 102 can correspond to an electronic module 200a which can, for example, be capable of performing one or more processing tasks in association with facilitating at least one measurable assessment result of trustworthiness. The measurable assessment result(s) of trustworthiness can, for example, be based on one or both of the earlier discussed trustworthiness score(s) and the earlier discussed overall score, in accordance with an embodiment of the disclosure.

The electronic module 200a can, for example, correspond to a mobile device which can be carried into the vehicle by a user or an installable electronic module (e.g., an electronic dashboard module) or an existing electronic control unit or ECU connected to the existing vehicle network having high performance computing capabilities, in accordance with an embodiment of the disclosure.

The electronic module 200a can, for example, include a casing 200b. Moreover, the electronic module 200a can, for example, carry any one of a first module 202, a second module 204, a third module 206, or any combination thereof.

In one embodiment, the electronic module 200a can carry a first module 202, a second module 204 and/or a third module 206. In a specific example, the electronic module 200a can carry a first module 202, a second module 204 and a third module 206, in accordance with an embodiment of the disclosure.

In this regard, it is appreciable that, in one embodiment, the casing 200b can be shaped and dimensioned to carry any one of the first module 202, the second module 204 and the third module 206, or any combination thereof.

The first module 202 can be coupled to one or both of the second module 204 and the third module 206. The second module 204 can be coupled to one or both of the first module 202 and the third module 206. The third module 206 can be coupled to one or both of the first module 202 and the second module 204. In one example, the first module 202 can be coupled to the second module 204 and the second module 204 can be coupled to the third module 206, in accordance with an embodiment of the disclosure. Coupling between the first module 202, the second module 204 and/or the third module 206 can, for example, be by manner of one or both of wired coupling and wireless coupling. Each of the first module 202, the second module 204 and the third module 206 can correspond to one or both of a hardware-based module and a software-based module, according to an embodiment of the disclosure.

In one example, the first module 202 can correspond to a hardware-based receiver which can be configured to receive one or more input signals.

The second module 204 can, for example, correspond to a hardware-based processor which can be configured to perform one or more processing tasks in association with any one of, or any combination of, the following:
feature selection-based processing
analysis-based processing
aggregation-based processing
   Specifically, the second module 204 can, for example, be configured to process the received input signal(s) by manner of feature selection-based processing, analysis-based processing and/or aggregation-based processing so as to generate/derive one or more output signal(s), in accordance with an embodiment of the disclosure.

The third module 206 can, in one example, correspond to a hardware-based transmitter which can be configured to communicate the output signal(s) from the electronic module 200a, in accordance with an embodiment of the disclosure. In another example, the third module 206 can correspond to a hardware-based display unit which can be configured to display the output signal(s) such that the output signal(s) can be visually perceivable (e.g., by one or more users). The output signal(s) can, for example, correspond to/include/be indicative of one or both of the trustworthiness score(s) and the overall score, in accordance with an embodiment of the disclosure. Moreover, the output signal(s) can, for example, be communicated from the electronic module 200a to one or more devices and/or one or more other apparatuses capable of, for example, displaying the output signal(s) for visual consumption (i.e., visually perceivable by one or more users).

The present disclosure contemplates the possibility that the first and second modules 202/204 can be an integrated software-hardware based module (e.g., an electronic part which can carry a software program/algorithm in association with receiving and processing functions/an electronic module programmed to perform the functions of receiving and processing). The present disclosure further contemplates the possibility that the first and third modules 202/206 can be an integrated software-hardware based module (e.g., an electronic part which can carry a software program/algorithm in association with receiving and transmitting functions/an electronic module programmed to perform the functions of receiving and transmitting). The present disclosure yet further contemplates the possibility that the first and third modules 202/206 can be an integrated hardware module (e.g., a hardware-based transceiver) capable of performing the functions of receiving and transmitting.

In view of the foregoing, it is appreciable that the present disclosure generally contemplates an apparatus 102 suitable for use for facilitating trustworthiness assessment in association with, for example, a vehicle (not shown), in accordance with an embodiment of the disclosure. The vehicle can, for example, be associated with a system infrastructure (e.g., a software-based infrastructure). For example, the system infrastructure associated with a vehicle can correspond to the earlier mentioned automotive-based software system, in accordance with an embodiment of the disclosure. Moreover, trustworthiness assessment can, for example, be based on one or both of at least one trustworthiness score and an overall score, in accordance with an embodiment of the disclosure. It is contemplated that the trustworthiness score(s) and/or the overall score can, for example, be an indicative assessment of trustworthiness in association with the system infrastructure, in accordance with an embodiment of the disclosure. In one embodiment, the apparatus 102 can be suitable for use for facilitating trustworthiness assessment in association with an automotive software system.

The apparatus 102 can include a first module 202 and a second module 204. The first module 202 can be coupled to the second module 204.

The first module 202 can be configured to receive at least one input signal and the second module 204 can be configured to process the input signal(s) in a manner so as so to generate one or more output signals.

The input signal(s) can, for example, be associated with one or both of at least one user requirement and at least one security objective (i.e., at least one user requirement and/or at least one security objective; at least one of at least one user requirement and at least one security objective), in accordance with an embodiment of the disclosure.

Moreover, in one embodiment, the input signal(s) can be processed by manner of:
identifying (e.g., by manner of feature selection-based processing) at least one security metric associated with at least one security requirement. The security requirement(s) can, for example, be based on at least one user requirement and/or at least one security objective, in accordance with an embodiment of the disclosure
determining (e.g., by manner of analysis-based processing) a positive determination, a negative determination or an indeterminate determination (i.e., one of a positive determination, a negative determination and an indeterminate determination) concerning fulfillment of a security metric in respect of at least one security objective and/or at least one user requirement
deriving (e.g., by manner of analysis-based processing) at least one trustworthiness score based on the positive determination, the negative determination or the indeterminate determination (i.e., one of the positive determination, the negative determination and the indeterminate determination)

In one embodiment, the output signal(s) can, for example, be based on the trustworthiness score(s). Moreover, the output signal(s) can be indicative of trustworthiness assessment, in accordance with an embodiment of the disclosure.

In one embodiment, the second module 204 can, for example, be configured to process the input signal(s) by manner of identifying a plurality of security metrics. Each security metric (of the plurality of security metrics) can, for example, be associated with at least one security objective and/or at least one user requirement. A trustworthiness score can, for example, be derived in association with each security metric based on a positive determination, a negative determination or an indeterminate determination (i.e., one of a positive determination, a negative determination and an indeterminate determination) concerning fulfillment of a security metric in respect of a security objective and/or a user requirement, in accordance with an embodiment of the disclosure.

In one embodiment, the second module 204 can, for example, be configured to derive a plurality of trustworthiness scores based on a plurality of security metrics.

In one embodiment, the second module 204 can, for example, be configured to aggregate the plurality of trustworthiness scores to generate an overall score. Additionally, trustworthiness assessment can, for example, be based on the overall score, in accordance with an embodiment of the disclosure.

In one embodiment, the apparatus 102 can further include a third module 206 which can, for example, be configured to communicate the output signal(s) to facilitate one or both of visual perception and audible perception (i.e., visual perception and/or audible perception, at least one of visual perception and audible perception) of one or both of the trustworthiness score(s) and the overall score (i.e., the trustworthiness score(s) and/or the overall score; at least one of the trustworthiness score(s) and the overall score).

It is contemplated that in the above manner at least one measurable assessment result of trustworthiness (i.e., trustworthiness assessment) can be facilitated, in accordance with an embodiment of the disclosure. Specifically, it is appreciable that the aforementioned trustworthiness score(s) and/or the overall score can, for example, relate to/correspond to at least one measurable assessment result of trustworthiness, in accordance with an embodiment of the disclosure.

It is contemplated that facilitating measurable assessment result of trustworthiness can, for example, facilitate a quantifiable overview of an automotive-based software system during the lifecycle of, for example, a vehicle (e.g., a car), in accordance with an embodiment of the disclosure. Such a quantifiable overview can, for example, be useful for, for example, a party of interest (e.g., developer(s), software architect(s), system architect(s) and/or security & privacy manager(s)). For example, identifying security metrics associated with an automotive-based software system trustworthiness can possibly generate one or more quantified scores associated with one or more security risks during development and/or deployment phase, which provides a party of interest (e.g., developer(s) and/or other stakeholder(s)) a brief and/or intuitive security assessment. It is contemplated that, in accordance with an embodiment of the disclosure, trustworthiness assessment can, for example, be communicated via an interactive dashboard (e.g., an electronic dashboard module) which can, for example, facilitate traceability of security defects in software modules/platforms associated with an automotive-based software system.

Moreover, it is contemplated that by manner of facilitating measurable assessment result of trustworthiness (i.e., trustworthiness evaluation), cybersecurity health of an automotive-based software system can be assessed before a vehicle is on the road. By doing so, the number of product (e.g., a vehicle) recalls due to software defects can potentially be at least reduced. Additionally, software defects can possibly be addressed during development lifecycle phase. In this regard, it is appreciable that overall software product development can, for example, be made more efficient and/or maintenance costs can possibly be reduced, in accordance with an embodiment of the disclosure.

It is contemplated that facilitating measurable assessment result of trustworthiness (i.e., trustworthiness evaluation) can be useful for, for example, assessing the security risks and generating a trustworthiness report, which can build the software trustworthiness databases for risk assessment during development phase, in accordance with an embodiment of the disclosure. It is further contemplated that facilitating measurable assessment result of trustworthiness (i.e., trustworthiness evaluation) can be useful for, for example, assigning one or more trustworthiness scores for automotive software modules associated with an automotive-based software system for one or more relevant stakeholders (e.g., user(s) of vehicle(s) and/or software architect(s)) so as to, for example, improve security level, in accordance with an embodiment of the disclosure (e.g., in connection with the aftermarket phase).

The above-described advantageous aspect(s) of the apparatus 102 of the present disclosure can also apply analogously (all) the aspect(s) of a below described processing method of the present disclosure. Likewise, all below described advantageous aspect(s) of the processing method of the disclosure can also apply analogously (all) the aspect(s) of above described apparatus 102 of the disclosure. It is to be appreciated that these remarks apply analogously to the earlier discussed system 100 of the present disclosure.

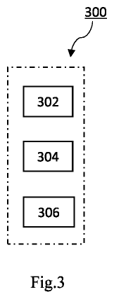

Referring to FIG. 3, a processing method in association with the system 100 is shown, according to an embodiment of the disclosure. The processing method 300 can, for example, be suitable for facilitating measurable assessment result of trustworthiness, in accordance with an embodiment of the disclosure, in accordance with an embodiment of the disclosure.

The processing method 300 can, for example, include any one of an input step 302, an analysis step 304 and an output step 306, or any combination thereof, in accordance with an embodiment of the disclosure.

In one embodiment, the processing method 300 can include an input step 302, an analysis step 304 and an output step 306. In another embodiment, the processing method 300 can include an input step 302 and an analysis step 304. In yet another embodiment, the processing method 300 can include an analysis step 304 and an output step 306. In yet a further embodiment, the processing method 300 can include an analysis step 304.

With regard to the input step 302, one or more input signals can be received. For example, the input signal(s) can be received by the apparatus(es) 102 for processing, in accordance with an embodiment of the disclosure.

With regard to the analysis step 304, the input signal(s) can be processed in a manner so as to generate/derive one or more output signal(s). For example, the received input signal(s) can be processed by the apparatus(es) 102 by manner of feature selection-based processing, analysis-based processing and/or aggregation-based processing so as to generate the output signal(s).

With regard to the output step 306, at least one output signal can be communicated. For example, the output signal(s) can correspond to/include/be associated with at least one trustworthiness score and/or an overall score, in accordance with an embodiment of the disclosure. The output signal(s) can, in one example, be communicated in a manner such that the trustworthiness score(s) and/or the overall score can be one or both of visually perceivable and audibly perceivable (i.e., visually perceivable and/or audibly perceivable). In another example, the output signal(s) can be communicable to one or more other apparatus(es) 102 and/or one or more device(s)/other device(s) 104. The output signal(s) can, for example, be communicated from at least one apparatus 102.

The present disclosure further contemplates a computer program (not shown) which can include instructions which, when the program is executed by a computer (not shown), cause the computer to carry out the input step 302, the analysis step 304 and/or the output step 306 as discussed with reference to the processing method 300. For example, in one embodiment, the analysis step 304 can be carried out when the instructions are executed by the computer.

The present disclosure yet further contemplates a computer readable storage medium (not shown) having data stored therein representing software executable by a computer (not shown), the software including instructions, when executed by the computer, to carry out the input step 302, the analysis step 304 and/or the output step 306 as discussed with reference to the processing method 300. For example, in one embodiment, the analysis step 304 can be carried out when the instructions are executed by the computer.

In view of the foregoing, it is appreciable that the present disclosure generally contemplates a processing method 300 which can, for example, be suitable for facilitation of trustworthiness assessment, in accordance with an embodiment of the disclosure. Trustworthiness assessment can be in association with, for example, a vehicle (not shown), in accordance with an embodiment of the disclosure. The vehicle can, for example, be associated with a system infrastructure (e.g., a software-based infrastructure). For example, the system infrastructure associated with a vehicle can correspond to the earlier mentioned automotive-based software system, in accordance with an embodiment of the disclosure. Moreover, trustworthiness assessment can, for example, be based on one or both of at least one trustworthiness score and an overall score, in accordance with an embodiment of the disclosure. It is contemplated that the trustworthiness score(s) and/or the overall score can, for example, be an indicative assessment of trustworthiness in association with the system infrastructure, in accordance with an embodiment of the disclosure. In one embodiment, the processing method 300 can, for example, be suitable for facilitating trustworthiness assessment in association with an automotive software system.

The processing method 300 can, for example, include an analysis step 304, in accordance with an embodiment of the disclosure.

In one embodiment, the analysis step 304 can, for example, include processing at least one input signal to generate at least one output signal.

The input signal(s) can, for example, be associated with/include/be indicative of one or both of at least one user requirement and at least one security objective (i.e., at least one user requirement and/or at least one security objective; at least one of at least one user requirement and at least one security objective).

In one embodiment, the input signal(s) can, for example, be processed by manner of:
identifying (e.g., by manner of feature selection-based processing) at least one security metric associated with at least one security requirement. The security requirement(s) can, for example, be based on the security objective(s) and/or the user requirement(s), in accordance with an embodiment of the disclosure.
determining (e.g., by manner of analysis-based processing) a positive determination, a negative determination or an indeterminate determination (i.e., one of a positive determination, a negative determination and an indeterminate determination) concerning fulfillment of a security metric in respect of at least one security objective and/or at least one user requirement
deriving (e.g., by manner of analysis-based processing) at least one trustworthiness score based on the positive determination, the negative determination or the indeterminate determination (i.e., one of the positive determination, the negative determination and the indeterminate determination)

In one embodiment, the output signal(s) can, for example, be based on the trustworthiness score(s).

In one embodiment, the output signal(s) can, for example, be indicative of trustworthiness assessment.

In one embodiment, the input signal(s) can, for example, be processed by manner of identifying a plurality of security metrics. Each security metric of the plurality of security metrics can, for example, be associated with at least one security objective and/or at least one user requirement.

In one embodiment, a trustworthiness score can, for example, be derived in association with each security metric based on a positive determination, a negative determination or an indeterminate determination (i.e., one of a positive determination, a negative determination and an indeterminate determination) concerning fulfillment of a security metric in respect of a security objective and/or a user requirement.

In one embodiment, a plurality of trustworthiness scores can, for example, be derived based on a plurality of security metrics.

In one embodiment, the processing method 300 can, for example, further include aggregating the plurality of trustworthiness scores to generate an overall score.

In one embodiment, trustworthiness assessment can, for example, be based on the overall score.

It is contemplated that in the above manner at least one measurable assessment result of trustworthiness (i.e., trustworthiness assessment) can be facilitated, in accordance with an embodiment of the disclosure. Specifically, it is appreciable that the aforementioned trustworthiness score(s) and/or the overall score can, for example, relate to/correspond to at least one measurable assessment result of trustworthiness, in accordance with an embodiment of the disclosure.

It is contemplated that facilitating measurable assessment result of trustworthiness can, for example, facilitate a quantifiable overview of an automotive-based software system during the lifecycle of, for example, a vehicle (e.g., a car), in accordance with an embodiment of the disclosure. Such a quantifiable overview can, for example, be useful for, for example, a party of interest (e.g., developer(s), software architect(s), system architect(s) and/or security & privacy manager(s)). For example, identifying security metrics associated with an automotive-based software system trustworthiness can possibly generate one or more quantified scores associated with one or more security risks during development and/or deployment phase, which provides a party of interest (e.g., developer(s) and/or other stakeholder(s)) a brief and/or intuitive security assessment. It is contemplated that, in accordance with an embodiment of the disclosure, trustworthiness assessment can, for example, be communicated via an interactive dashboard (e.g., an electronic dashboard module) which can, for example, facilitate traceability of security defects in software modules/platforms associated with an automotive-based software system.

Moreover, it is contemplated that by manner of facilitating measurable assessment result of trustworthiness (i.e., trustworthiness evaluation), cybersecurity health of an automotive-based software system can be assessed before a vehicle is on the road.

By doing so, the number of product (e.g., a vehicle) recalls due to software defects can potentially be at least reduced. Additionally, software defects can possibly be addressed during development lifecycle phase. In this regard, it is appreciable that overall software product development can, for example, be made more efficient and/or maintenance costs can possibly be reduced, in accordance with an embodiment of the disclosure.

It is contemplated that facilitating measurable assessment result of trustworthiness (i.e., trustworthiness evaluation) can be useful for, for example, assessing the security risks and generating a trustworthiness report, which can build the software trustworthiness databases for risk assessment during development phase, in accordance with an embodiment of the disclosure. It is further contemplated that facilitating measurable assessment result of trustworthiness (i.e., trustworthiness evaluation) can be useful for, for example, assigning one or more trustworthiness scores for automotive software modules associated with an automotive-based software system for one or more relevant stakeholders (e.g., user(s) of vehicle(s) and/or software architect(s)) so as to, for example, improve security level, in accordance with an embodiment of the disclosure (e.g., in connection with the aftermarket phase).

It should be appreciated that the embodiments described above can be combined in any manner as appropriate (e.g., one or more embodiments as discussed in the “Detailed Description” section can be combined with one or more embodiments as described in the “Summary of the Invention” section).

It should be further appreciated by the person skilled in the art that variations and combinations of embodiments described above, not being alternatives or substitutes, may be combined to form yet further embodiments.

In one example, the communication network 106 can be omitted. Communication (i.e., between the apparatus(es) 102 and the device(s) 104) can be by manner of direct coupling. Such direct coupling can be by manner of one or both of wired coupling and wireless coupling.

In another example, the example context as discussed earlier can be associated with a vehicle. The present disclosure contemplates that other example contexts can be possible. For example, another example context can be associated with a consumer electric appliance (e.g., a laptop or a Smart television).

In yet another example, it was earlier contemplated that the third module 206 can, for example, correspond to a hardware-based display unit which can be configured to display the output signal(s) such that the output signal(s) can be visually perceivable (e.g., by one or more users). The present disclosure contemplates that the third module 206 can, for example, correspond to a hardware-based audio unit which can be configured to audibly output the output signal(s) such that the output signal(s) can be audibly perceivable (e.g., by one or more users).

In yet another additional example, the third module 206 can, for example, correspond to a hardware-based audio-display unit which can be configured to communicate the output signal(s) such that the output signal(s) can be audibly and visually perceivable (e.g., by one or more users).

In the foregoing manner, various embodiments of the disclosure are described for addressing at least one of the foregoing disadvantages. Such embodiments are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

1-10. (canceled)

11. An apparatus for facilitating a trustworthiness assessment in an association with an automotive software system, the apparatus comprising:
a first module (202) configured to receive at least one input signal associated with at least one of:
at least one user requirement, or
at least one security objective; and
a second module communicating with the first module, the second module being configured to process the at least one input signal so as so generate at least one output signal, wherein the second module is configured to process the at least one input signal by:
identifying at least one security metric associated with at least one security requirement, the at least one security requirement being based on at least one of the at least one user requirement or the at least one security objective,
determining one of a positive determination, a negative determination or an indeterminate determination concerning a fulfillment of the at least one security metric with respect to at least one of the at least one security objective or the at least one user requirement,
deriving at least one trustworthiness score based on one of the positive determination, the negative determination or the indeterminate determination,
wherein the at least one output signal is based on the at least one trustworthiness score, and
wherein the at least one output signal is indicative of the trustworthiness assessment.

12. The apparatus according to claim 11,
wherein the at least one security metric includes a plurality of security metrics,
wherein the second module is configured to process the at least one input signal by identifying the plurality of security metrics, and
wherein the trustworthiness score is derivable in association with each of the plurality of security metrics based on one of a positive determination, a negative determination or an indeterminate determination concerning a fulfillment of a respective metric of the plurality of security metrics with respect to at least one of a security objective or a user requirement.

13. The apparatus according to claim 11,
wherein the at least one trustworthiness score includes a plurality of trustworthiness scores,
wherein the at least one security metric includes a plurality of security metrics, and
wherein the second module is further configured to derive the plurality of trustworthiness scores based on the plurality of security metrics.

14. The apparatus according to claim 11,
wherein the at least one trustworthiness score includes a plurality of trustworthiness scores,
wherein the second module is further configured to aggregate the plurality of trustworthiness scores to generate an overall score, and
wherein the trustworthiness assessment is based on the overall score.

15. The apparatus according to claim 14, further comprising a third module configured to communicate the at least one output signal so as to facilitate at least one of a visual perception or an audible perception of at least one of:
the at least one trustworthiness score, or
the overall score.

16. A processing method for facilitating a trustworthiness assessment in association with an automotive software system, the processing method comprising:
processing, by the apparatus, at least one input signal so as to generate at least one output signal, the at least one input signal being associated with at least one of:
at least one user requirement, or
at least one security objective,
wherein the at least one input signal being processible by:
identifying at least one security metric associated with at least one security requirement based on at least one of the at least one user requirement or the at least one security objective,
determining one of a positive determination, a negative determination or an indeterminate determination concerning a fulfillment of the at least one security metric with respect to at least one of the at least one user requirement or the at least one security objective,
deriving at least one trustworthiness score based on one of the positive determination, the negative determination or the indeterminate determination,
wherein the at least one output signal is based on the at least one trustworthiness score, and
wherein the at least one output signal is indicative of the trustworthiness assessment.

17. The processing method according to claim 16,
wherein the at least one security metric includes a plurality of security metrics,
wherein the at least one input signal is processable by identifying the plurality of security metrics, and
wherein the trustworthiness score is derivable in association with each of the plurality of security metrics based on one of a positive determination, a negative determination or an indeterminate determination concerning a fulfillment of a respective metric of the plurality of security metrics with respect to at least one of a security objective or a user requirement.

18. The processing method according to claim 16, wherein the at least one trustworthiness score includes a plurality of trustworthiness scores, and wherein the at least one security metric includes a plurality of security metrics,
further comprising deriving the plurality of trustworthiness scores based on the plurality of security metrics.

19. The processing method according to claim 16, wherein the at least one trustworthiness score includes a plurality of trustworthiness scores, further comprising aggregating the plurality of trustworthiness scores to generate an overall score, and wherein the trustworthiness assessment is based on the overall score.

20. The processing method according to claim 19, further comprising communicating the at least one output signal so as to facilitate at least one of a visual perception or an audible perception of at least one of:
the at least one trustworthiness score, or
the overall score.

21. A computer-accessible medium that includes instructions which, when executed by a computer, cause the computer to perform procedures comprising:
processing at least one input signal so as to generate at least one output signal, the at least one input signal being associated with at least one of:
at least one user requirement, or
at least one security objective,
wherein the at least one input signal being processible by:
identifying at least one security metric associated with at least one security requirement based on at least one of the at least one user requirement or the at least one security objective,
determining one of a positive determination, a negative determination or an indeterminate determination concerning a fulfillment of the at least one security metric with respect to at least one of the at least one user requirement or the at least one security objective,
deriving at least one trustworthiness score based on one of the positive determination, the negative determination or the indeterminate determination,
wherein the at least one output signal is based on the at least one trustworthiness score, and

[symbol]

22. The computer-accessible medium according to claim 21,
wherein the at least one security metric includes a plurality of security metrics,
wherein the at least one input signal is processable by identifying the plurality of security metrics, and
wherein the trustworthiness score is derivable in association with each of the plurality of security metrics based on one of a positive determination, a negative determination or an indeterminate determination concerning a fulfillment of a respective metric of the plurality of security metrics with respect to at least one of a security objective or a user requirement.

23. The computer-accessible medium according to claim 21,
wherein the at least one trustworthiness score includes a plurality of trustworthiness scores,
wherein the at least one security metric includes a plurality of security metrics, and
wherein the computer is further configured to derive the plurality of trustworthiness scores based on the plurality of security metrics.

24. The computer-accessible medium according to claim 21, wherein the at least one trustworthiness score includes a plurality of trustworthiness scores, wherein the computer is further configured to aggregate the plurality of trustworthiness scores to generate an overall score, and wherein the trustworthiness assessment is based on the overall score.

25. The computer-accessible medium according to claim 24, wherein the computer is further configured to communicate the at least one output signal so as to facilitate at least one of a visual perception or an audible perception of at least one of:
the at least one trustworthiness score, or
the overall score.
